(19) United States
(12) Patent Application Publication
(10) Pub. No.: US 2019/0232873 A1
(43) Pub. Date: Aug. 1, 2019

(54) MIRROR ASSEMBLY FOR A VEHICLE

(71) Applicant: Ficomirrors, S.A.U., Barcelona (ES)

(72) Inventors: David Gómez Timoneda, Barcelona (ES); Frédéric Lorival, TORFOU (FR); Robert López Galera, Barcelona (ES); Oriol Biosca Yuste, Catalonia (ES)

(21) Appl. No.: 16/381,968

(22) Filed: Apr. 11, 2019

Related U.S. Application Data
(63) Continuation-in-part of application No. 15/456,862, filed on Mar. 13, 2017, now Pat. No. 10,286,845.

(30) Foreign Application Priority Data
Mar. 14, 2016 (EP) 16382112.7

(51) Int. Cl. B60R 1/08; B60R 1/04; B60R 1/12

(52) U.S. Cl. CPC B60R 1/087; B60R 1/04; B60R 2001/1215; B60R 2001/1223; B60R 1/12

(57) ABSTRACT

A mirror assembly includes a housing, a reflective element, a display, a light sensor, a controller, and an interface. The reflective element is adapted to change beween high and low reflection states. The display is positioned behind, and visible through, the reflective element when activated and the switchable reflective element is in the low reflection state. The sensor is configured to output a light signal. The controller is configured to receive the signal, compare the signal to a threshold, and output a signal to the switchable reflective element to facilitate changing between the high and low reflection states and based on the comparison. The controller outputs a signal to activate the display when the switchable reflective element is in the low reflection state. The interface outputs a signal to the controller to activate the display and place the reflective element in the low reflection state regardless of the light signal.

### CROSS-REFERENCES TO RELATED APPLICATIONS

This application claims priority to U.S. application Ser. No. 15/456,862, filed Mar. 13, 2017, which claims priority to European patent application no. 16382112.7, filed on Mar. 14, 2016, which are incorporated herein by reference, in their entirety.

### BACKGROUND

The present invention relates to a mirror assembly for a vehicle, belonging to the field of rear view mirror assemblies.

It is known in the art providing display mirror assemblies that may operate in a mirror mode or in a display mode.

US 2015/0277203 A1, referred to an “Automatic display mirror assembly” discloses a display mirror assembly for a vehicle which includes an electrochromic cell, a switchable reflective element, a display module, an ambient light sensor, and a controller. The controller automatically selects a display mode or a mirror mode in response to a detected ambient light level. In a display mode, the controller activates the display module, sets the switchable reflective element to a low reflection mode, and sets the electrochromic cell to a clear state with minimum attenuation. In a mirror mode, the controller deactivates the display module, sets the switchable reflective element to a high reflection mode, and varies attenuation by the electrochromic cell.

One drawback of this configuration of display mirror assembly is that it requires an additional element, such as an electrochromic cell, to control the amount of reflected light, thus attenuating the light passing therethrough.

### SUMMARY

A mirror assembly according to one, non-limiting, exemplary embodiment of the present disclosure includes a housing, a reflective element, a display, a light sensor, a controller, and an interface. The reflective element is adapted to change beween high and low reflection states. The display is positioned behind, and visible through, the reflective element when activated and the switchable reflective element is in the low reflection state. The sensor is configured to output a light signal. The controller is configured to receive the signal, compare the signal to a threshold, and output a signal to the switchable reflective element to facilitate changing between the high and low reflection states and based on the comparison. The controller outputs a signal to activate the display when the switchable reflective element is in the low reflection state. The interface outputs a signal to the controller to activate the display and place the reflective element in the low reflection state regardless of the light signal.

A mirror assembly according to another embodiment includes a housing, a switchable reflective element, a display, a human-machine interface, and a controller. The switchable reflective element is supported by the housing, and is adapted to change between low and high reflection states. The display is supported by the housing, and is positioned behind the switchable reflective element, and is adapted to switch between activated and deactivated states. The human-machine interface includes a button mounted to the housing, and is adapted to output a signal upon actuation by a user. The controller is adapted to receive the signal, and based on the signal, place the display in the activated state and the switchable reflective element in the low reflection state, or place the display in the deactivated state and the switchable reflective element in the high reflection state.

Other advantageous embodiments will be described in the dependent claims.

### BRIEF DESCRIPTION OF THE DRAWINGS

For a more complete understanding of the present disclosure, it will be described below in greater detail, making reference to the attached drawings, in which:

FIG. 1 is a perspective view of the mirror assembly for a vehicle as one exemplary, non-limiting, embodiment of the present disclosure.

FIG. 2 is a schematic representation of the switchable reflective element and the display of the mirror assembly in a display mode.

FIG. 3 is a schematic representation of the switchable reflective element and the display of the mirror assembly in a mirror mode.

FIG. 4 is a schematic representation of an actuator as one, non-limiting, embodiment of a human-machine interface of the mirror assembly in a first position.

FIG. 5 is a schematic representation of the actuator in a second position.

FIG. 6 is a schematic representation of the switchable reflective element and the display of the mirror assembly in a dimming mirror mode.

FIG. 7 is a schematic representation of another embodiment of the mirror assembly with the switchable reflective element comprising several individual switchable reflective elements, together with the display.

### DETAILED DESCRIPTION

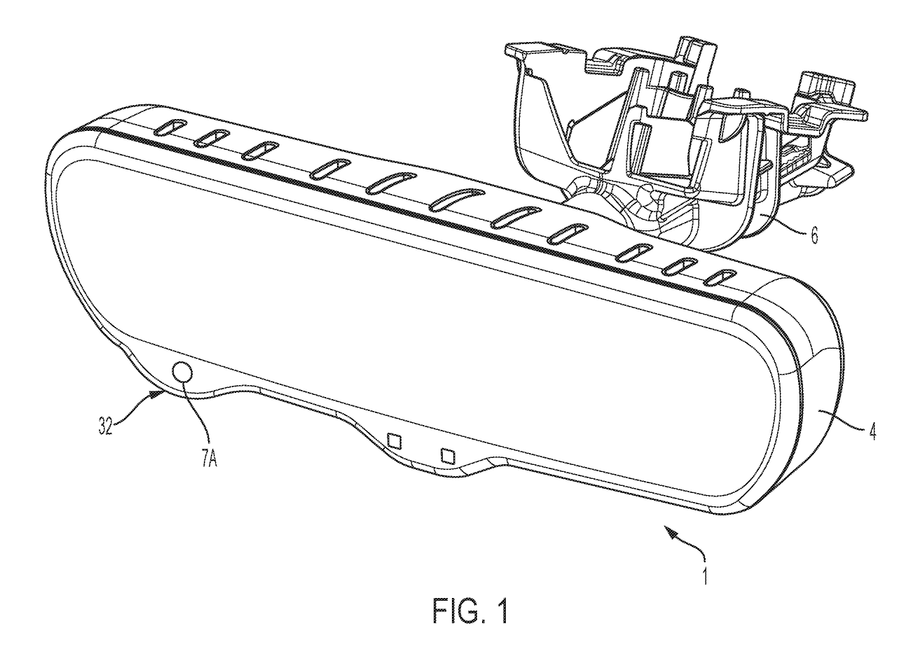

FIG. 1 is a perspective view of a mirror assembly 1 including a housing 4 and a mounting means 6. The mounting means 6 serves to attach the mirror assembly 1 to a vehicle (for instance, to the windshield or another element).

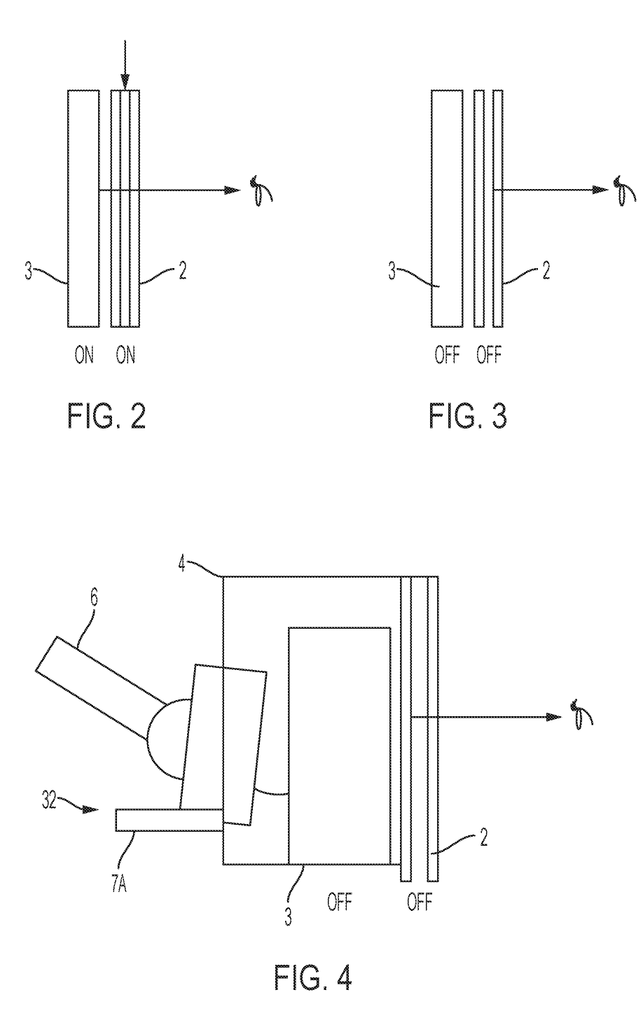

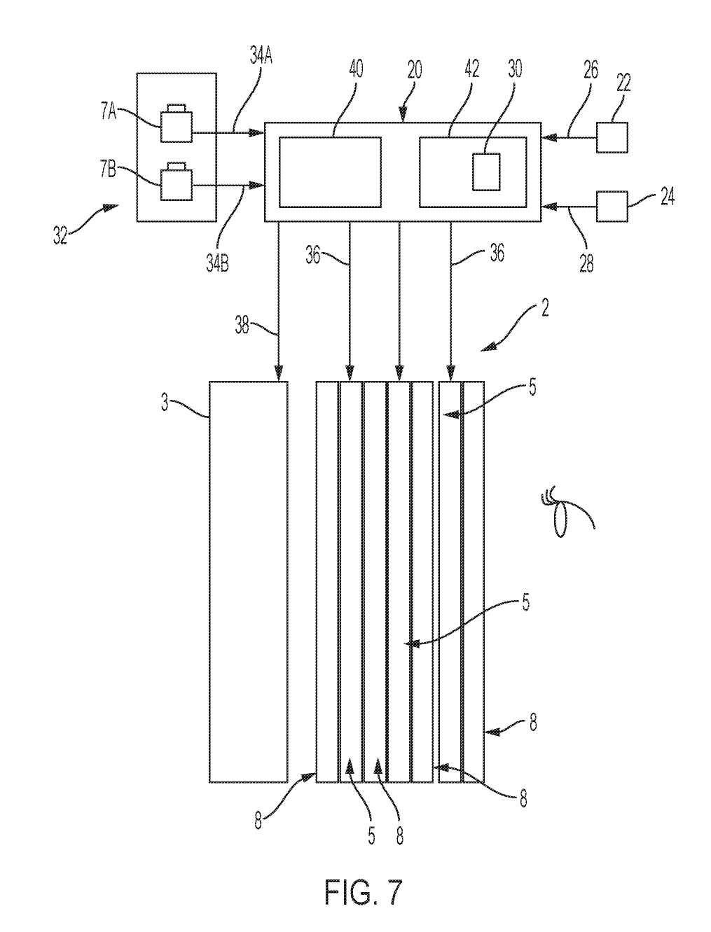

The mirror assembly 1 comprises:
a switchable reflective element 2, that can change between a high reflection state and a low reflection state;
a controller 20 (see FIGS. 2 and 7) communicating with the switchable reflective element 2, the controller 20 being able to change the switchable reflective element 2 between a high reflection state and a low reflection state; and
a housing 4 configured for attachment to the vehicle and housing at least the switchable reflective element 2.

According to an embodiment of the mirror assembly 1, the high reflection state of the switchable reflective element 2 has a reflectivity greater than 40%, and the low reflection state of the switchable reflective element 2 has a reflectivity of less than 10% and a transmissivity greater than 80%.

Some examples of switchable reflective elements suitable for the mirror assembly 1 can be found in U.S. Pat. No. 6,674,504 B1.

According to another embodiment of the mirror assembly 1, the switchable reflective element 2 comprises several individual switchable reflective elements 5 having only two possible states. a high reflection state and a low reflection state and arranged in parallel (see FIG. 7). Depending on the desired reflection state for the switchable reflective element 2, the necessary number of individual switchable reflective elements 5 will be activated or deactivated, thus regulating the reflection state of the switchable reflective element 2 to obtain intermediate reflection states between the high reflection state and the low reflection state.

In FIG. 7 it can also be seen that the switchable reflective element 2 also comprises a number of glass layers 8 such that the individual switchable reflective elements 5 are placed between two glass layers 8. The layers corresponding to the individual switchable reflective elements 5 can be made of ITO+a switchable reflective element+ITO (ITO standing for indium tin oxide).

According to another embodiment of the mirror assembly 1, it is also possible to obtain intermediate reflection states of the switchable reflective element 2 between the high reflection state and the low reflection state. The regulation is made by the controller 20.

The mirror assembly 1 can additionally comprise at least one ambient light sensor (i.e., two illustrated as 22, 24 in FIGS. 2 and 7) for sensing an ambient light level and giving respective ambient light signals 26, 28, each representative of the sensed ambient light level. The ambient light sensors also communicate with the controller 20, such that the regulation of the reflection state of the switchable reflective element 2 depends on the ambient light signal(s) 26, 28.

In one embodiment of the mirror assembly 1 comprises two ambient light sensors 22, 24, such that one ambient light sensor 22 senses an ambient light level inside the vehicle and one ambient light sensor 24 senses an ambient light level outside the vehicle.

According to another option, the ambient light sensor(s) 22, 24 communicates with the controller 20, and the controller 20 compares the ambient light signals 26, 28 with a threshold value 30 (see FIG. 7) preprogrammed into the controller 20 such that:
when one or more of the ambient light signals 26, 28 exceed the threshold value 30 the controller 20 may output signal(s) 36 (see FIG. 7) that facilitate the switching of the switchable reflective element 2 to the low reflection state, and
when one or more of the ambient light signals 26, 28 does not exceed the threshold value 30 the controller 20 may output signal(s) 36 that facilitate the switching of the switchable reflective element 2 to the high reflection state.

In this option the reflection states of the switchable reflective element 2 can be automatically switched from the high reflection state to the low reflection state and vice-versa.

The signal 36 may represent electric energy provided to the switchable reflective element 2 needed to maintain a high reflection state. In this example, simply depriving the switchable reflective element 2 of this energy will place the switchable reflective elemnt 2 in the low reflection state. Therefore, the controller 20 only outputs the signal 36 to maintain the high reflection state. In another example, a reverse logic may apply, where the signal 36 is only outputted by the controller to maintain the switchable reflective element 2 in a low reflection state.

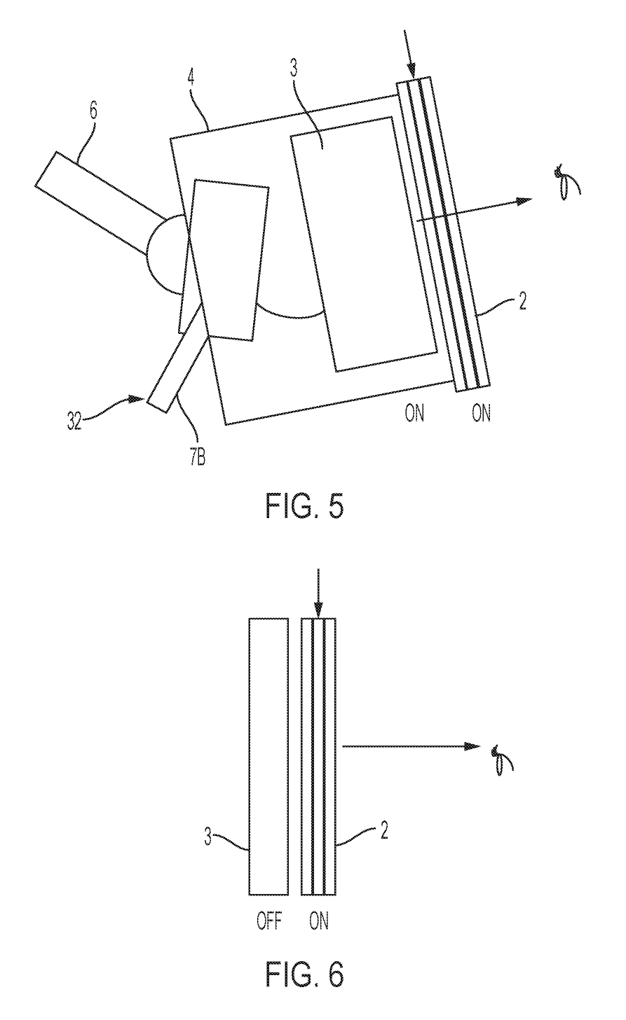

According to another option, the reflection state of the switchable reflective element 2 can be manually regulated by a user by means of a human-machine interface 32 (see FIGS. 1 and 7). In one example, the switch elements 7A, 7B of the human-machine interface 32 are in communication with the controller 20 via respective signals (see arrows 34A, 34B in FIG. 7). The human-machine interface 32 may include at least one switchng element (i.e., two illustrated as 7A, 7B, see FIG. 7). The first switch element 7A is constructed to switch the mirror assembly between mirror and reflection modes. The second switch element 7B is constructed to activate and deactivate the display 3 independently from the high and low reflection states of the switchable reflective element 2. It is contemplated and understood that various embodiments of the mirror assembly 1 can include only the switch element 7A or the switch element 7B. In yet another embodiment, the switch element 7A may be configured to switch the display 3 and the reflective element 2, without needing the switch element 7B (see FIGS. 4 and 5).

The human-machine interface 32 can be placed on the housing 4 of the mirror assembly 1. According to another option, it can be separated from the housing 4 of the mirror assembly 1 (for instance, on the levers of the steering wheel or in a dash, not shown). In yet another example, the human-machine interface 32 may be distributed betweenb the housing 4 and remote locations from the mirror assembly 1.

According to another embodiment, the mirror assembly 1 additionally comprises a display 3 positioned behind the switchable reflective element 2 for displaying an image visible through the switchable reflective element 2. The display 3 is able to change between an activated state and a deactivated state, and to communicate with the controller 20 via signal (see arrow 38 in FIG. 7), such that the display 3 can be deactivated when the switchable reflective element 2 is in the high reflection state, in the low reflection state or in any intermediate reflection state.

FIGS. 2 and 3 show the switchable reflective element 2 and the display 3 of an embodiment of the mirror assembly 1, in a display mode and in a mirror mode, respectively.

In the basic function of the mirror assembly 1, when the mirror assembly 1 is placed in the display mode by the user, or driver, via the switch element 7A (e.g., a button, see FIG. 1) of the human-machine interface 32, the display 3 is switched ON (i.e., activated state) and the switchable reflective element 2 is switched to its low reflection state (FIG. 2), and the driver is able to see the image from the display 3 through the switchable reflective element 2. In the example of the switch element 7A being a button, the button may be mounted to, and supported by the housing 4 of the mirror assembly 1 for easy reach by a driver.

When the mirror assembly 1 is placed in the mirror mode by the driver via the human-machine interface 32, the display 3 is switched OFF (i.e., deactivated state) and the switchable reflective element 2 is switched to its high reflection state (FIG. 3), and the driver is able to see the light reflected by the switchable reflective element 2.

Referring to FIGS. 4 and 5, the switch element 7A of the human machine interface 32 of the mirror assembly 1 can be an actuator, or lever, adapted for moving the switchable reflective element 2 between a first position (see FIG. 4) and a second position (see FIG. 5), the second position being tilted with respect to the first position. For the embodiments including a display 3, the lever 7A of the human-machine interface 32 can also move the display 3 together with the switchable reflective element 2.

FIG. 4 shows the lever 7A of the human-machine interface 32, the switchable reflective element 2, and the display 3 of an embodiment of the mirror assembly 1 in the first position, where the switchable reflective element 2 and the display 3 are in the mirror mode.

FIG. 5 shows the lever 7A of the human-machine interface 32, the switchable reflective element 2, and the display 3 of an embodiment of the mirror assembly 1 in the second position, where both the switchable reflective element 2 and the display 3 are in the display mode.

In the embodiment of FIGS. 4 and 5, when the switchable reflective element 2 is activated by the driver through the lever 7A of the human-machine interface 32, it means at the same time a tilting movement, as the second position, is tilted with respect to the first position. The display 3 is switched ON (i.e., activated state) and the switchable reflective element 2 is switched to the low reflection state, and the driver is able to see the image from the display 3 through the switchable reflective element 2 (FIG. 5).

When the switchable reflective element 2 is deactivated by the driver through the lever 7A, it means at the same time a tilting movement that lets the driver see the image from the rear part of the vehicle. The display 3 is switched OFF (i.e., deactivated state) and the switchable reflective element 2 is switched to the high reflection state, and the driver is able to see the light reflected by the switchable reflective element 2 (FIG. 4).

In one embodiment, the mounting means 6 is pivotally connected to the housing 4, and the housing 4 supports the display 3 and the switchable reflective element 2. The display 3 and the switchable reflective element 2 may be fixed to the housing 4, and tilt with respect to the mounting means 6. In one example, the controller 20 is fixed to, and supported by, the mounting means 6. In another embodiment, the controller 20 is fixed to, and support by, the housing 4.

FIG. 6 shows the switchable reflective element 2 and the display 3 of an embodiment of the mirror assembly 1, in a dimming mirror mode.

As previously stated, the human-machine interface 32 of the mirror assembly 1 can also comprise the switch element 7B (see FIG. 7) to activate and deactivate only the display 3, independently of the high and low reflection states of the switchable reflective element 2. In FIG. 6 it can be seen that the switchable reflective element 2 is in the low reflection state and the display 3 has been switched to the deactivate state via, for example, the switch element 7B. In this situation, if the display 3 is dark, the light is reflected by the display 3, obtaining a dimming effect, in which only a small part of the light received by the switchable reflective element 2 reaches the driver, in this way avoiding moving, or tilting, the mirror assembly 1 via the switch element 7A.

Referring to FIG. 7, and in some embodiments, the controller 20 includes one or more processors 40 (i.e., one illustrated in FIG. 7) and one or more electronic storage mediums 42 (i.e., one illustrated in FIG. 7). In one example, the processor 40 is a microprocessor, or is other control circuitry such as analog and/or digital control circuitry including application specific integrated circuit (ASIC) for processing data as is known by one with skill in the art. In one example, the storage medium 42 is a non-volatile memory, such as electrically erasable programmable read-only memory (EEPROM) for storing one or more routines, thresholds, and captured data, hereafter referred to as application(s). The applications are executed by one or more of the processors 40 to enable operation, or functioning, of the mirror assembly 1. Another example of the electronic storage medium 42 is a non-transitory storage medium

The various functions described above may be implemented or supported by a computer program that is formed from computer readable program codes, and that is embodied in a computer readable medium. Computer readable program codes may include source codes, object codes, executable codes, and others. Computer readable mediums may be any type of media capable of being accessed by a computer, and may include Read Only Memory (ROM), Random Access Memory (RAM), a hard disk drive, a compact disc (CD), a digital video disc (DVD), or other non-transitory forms.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms used herein such as component, application, module, system, and the like are intended to refer to a computer-related entity, either hardware, a combination of hardware and software, or software execution. By way of example, an application may be, but is not limited to, a process running on a processor, a processor, an object, an executable, a thread of execution, a program, and/or a computer. An application running on a server and the server, may be a component. One or more applications may reside within a process and/or thread of execution and an application may be localized on one computer and/or distributed between two or more computers.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

What is claimed is:

1. A mirror assembly for a vehicle, comprising:
a housing;
a switchable reflective element supported by the housing and adapted to change beween high and low reflection states;
a display supported by the housing and positioned behind the switchable reflective element and being visible through the switchable reflective element when activated and the switchable reflective element is in the low reflection state;
a light sensor configured to output a light signal;
a controller configured to receive the light signal, compare the light signal to a prescribed light threshold and output a signal to the switchable reflective element to facilitate changing between the high and low reflection states and based on the comparison between the light signal and the prescribed light threshold, and the controller configured to output a user command signal to activate the display when the switchable reflective element is in the low reflection state; and
a human-machine interface configured to output a user command signal to the controller to facilitate activation of the display and placing the switchable reflective element in the low reflection state regardless of the light signal.

2. The mirror assembly set forth in claim 1, wherein the human-machine interface includes a button mounted to a front face of the housing, and adapted to be operated by the user to facilitate the output of the user command signal.

3. The mirror assembly set forth in claim 1, wherein the human-machine interface includes a lever adapted to tilt at least one of the housing, the display, and the switchable reflective element, and wherein the tilting switches the switchable reflective element between the high and low reflective states, and the display between respective deactivated and activated states.

4. The mirror assembly set forth in claim 1, wherein the human-machine interface is remotely located from the housing, the display, and the switchable reflective element.

5. The mirror assembly set forth in claim 4, wherein the human-machine interface is located in a dash of a vehicle.

6. The mirror assembly set forth in claim 1, wherein the controller is configured to deactivate the display when the switchable reflective element is in the high reflection state.

7. The mirror assembly set forth in claim 1, wherein the switchable reflective element includes a plurality of individual switchable reflective elements each configured to change only between the high reflection state and the low reflection state, and wherein the plurality of individual switchable reflective elements are arranged in parallel to one-another to obtain intermediate reflection states between the high reflection state and the low reflection state of the switchable reflective element.

8. The mirror assembly set forth in claim 2, wherein the switchable reflective element includes a plurality of individual switchable reflective elements arranged in parallel to one-another.

9. The mirror assembly set forth in claim 3, wherein the switchable reflective element includes a plurality of individual switchable reflective elements arranged in parallel to one-another.

10. The mirror assembly set forth in claim 4, wherein the switchable reflective element includes a plurality of individual switchable reflective elements arranged in parallel to one-another.

11. The mirror assembly set forth in claim 1, wherein the controller includes a processor and a non-transitory storage medium configured to store the prescribed light threshold.

12. The mirror assembly set forth in claim 1, wherein the human-machine interface includes a first switch element adapted to switch the mirror assembly between display and mirror modes, and a second switch element adapted to switch the display between the activated and deactivated states independent of the switchable reflective element state.

13. The mirror assembly set forth in claim 12, wherein the first swich element is a lever adapted to tilt the housing.

14. The mirror assembly set forth in claim 13, further comprising:
a mounting means adapted to be secured to a windshield of the vehicle, the housing adapted to tilt with respect to the mounting means.

15. A mirror assembly comprising:
a housing;
a switchable reflective element supported by the housing and adapted to change between low and high reflection states;
a display supported by the housing and positioned behind the switchable reflective element and adapted to switch between activated and deactivated states;
a human-machine interface including a button mounted to the housing and adapted to output a signal upon actuation by a user; and
controller adapted to receive the signal, and based on the signal place the display in the activated state and the switchable reflective element in the low reflection state, or place the display in the deactivated state and the switchable reflective element in the high reflection state.

16. The mirror assembly set forth in claim 15, further comprising:
a light sensor configured to output a light signal to the controller, wherein a processor of the controller is configured to compare the light signal to a prescribed light threshold stored in an electronic storage medium of the controller and switch the display display states and switchable reflective element based on the comparison.

17. The mirror assembly set forth in claim 16, wherein the human-machine interface includes a switch element adapted to override the light signal and place the display in the activated state independent of the state of the switchable reflective element.
